(19) United States
(12) Patent Application Publication
(10) Pub. No.: US 2003/0149721 A1
(43) Pub. Date: Aug. 7, 2003

(54) Method and device for synchronising a programme running on a first computer with a programme running on a server, computer-readable storage medium and computer programme element

(76) Inventors: Luis-Alfredo Alfonso-Nogueiro, Poing (DE); Hans-Georg Baumgarten, Munich (DE); Evelyn Pfeuffer, Munich (DE)

Correspondence Address: MORRISON & FOERSTER LLP, 1650 TYSONS BOULEVARD, SUITE 300, MCLEAN, VA, 22102, US

(21) Appl. No.: 10/204,704

(22) PCT Filed: Jan. 11, 2001
(86) PCT No.: PCT/DE01/00093

(30) Foreign Application Priority Data
Feb. 24, 2000 (DE) 100 08 616.0

(51) Int. Cl. G06F 15/16

(52) U.S. Cl. 709/203

(57) ABSTRACT

The program that is running on the server continues to run without a connection to the first computer and carries out state changes. As soon as an existing connection has been interrupted, the state of the first computer is stored within the program that is running on the server. The program is continued and state changes are logged. The state changes are initiated by the server. Once a new connection has been established, the programs are synchronized.

### CLAIM FOR PRIORITY

This application claims priority to International Application No. PCT/DE01/00093 which was published in the German language on Aug. 30, 2001.

### TECHNICAL FIELD OF THE INVENTION

The invention relates to a method and an arrangement for synchronizing a program running on a first computer with a program running on a server. Such a method and such an arrangement are known from [1].

### BACKGROUND OF THE INVENTION

In the case of the method known from [1], a database program runs EP 0 862 123 discloses a database having a program running on a server and on a plurality of computers which have read and/or write access to the database, which is stored in a memory in the server, and are able to change the content of said database. If a connection between a computer and the server, for example a connection via a radio interface, is interrupted, then access operations by further computers which are still connected to the server can cause state changes in the database program, that is to say e.g. particularly in the database provided by the server. If the computer whose connection was interrupted now in turn sets up a connection again, then state changes need to resolve inconsistencies, which have arisen on account of access operations by the further computers, in the data stored in the database using suitable mechanisms, for example by executing prescribed scripts or by automatically updating the database, which are also stored on the corresponding computers.

It should be noted that, in the ease of the method known from [1], state changes in the database can be produced exclusively by the computers connected to the server.

For a distributed application, that is to say for e.g. a program which runs on a plurality of computers and is administered by a server, for example in the case of an application which can be used by the computers to retrieve bank data via the communications link (online banking), it is also known that if a connection exists between a computer and the server [lacuna] during an inherently running application, the respective state is stored for the user, that is to say e.g. for the respective computer. If a connection is set up between the computer and the server again, then the stored state is reconstructed. With this type of distributed application, there is only interaction with one respective computer. Other computers cannot make any state changes which influence states relating to the respective computer.

A drawback of the known practices is that, particularly in the case of a distributed application operated by the server where the server itself can also make state changes even though a connection between the computer and the server has been interrupted, can be caused, it is not possible, following renewed connection setup for the respective computer, to “reenter” that state in the distributed application which corresponds to the state in which the connection to the computer was interrupted.

This can be attributed, in particular, to the fact that the distributed application, particularly in the case of a distributed application where the server continuously makes state changes autonomously, a very large state machine is clearly formed which is not readily comprehensible and is thus also not readily reconstructable.

The particular problem with such an application is that, in the event of a computer's connection being terminated, after a certain time there has already been significant progress in the execution of the program executed by the server, that is to say e.g. of the distributed application, from the user's point of view. This progress in the program cannot now be reconstructed with the known methods.

The drawbacks described above are particularly serious in the case of a connection between a computer and the server which is interrupted relatively frequently, that is to say is very susceptible to interference, for example in the case of a connection via a radio interface.

An example of such a system is when the mobile computer is a mobile phone which communicates with the server using the Wireless Access Protocol (WAP).

### SUMMARY OF THE INVENTION

The invention discloses is thus based on the object of allowing a distributed application to be synchronized after a computer involved in this application with the program running on the computer has not been connected to the server for a certain time, when state changes in the distributed application can be produced by the server.

This object is achieved by the method, the arrangement, the computer readable storage medium and the computer program element having the features based on the independent patent claims.

In the ease of In one embodiment of the invention, there is a method for synchronizing a program running on a first computer with a program running on a server, where the program running on the server continues to run and makes state changes even when the server is not connected to the first computer, the server stores the state of the first computer within the program running on the server as soon as a connection which has existed hitherto between the first computer and the server has been interrupted. The program running on the server is continued when the connection to the first computer has been interrupted, with state changes in the program running on the server being logged. At least some of the state changes are caused by the server itself. A fresh connection between the first computer and the server is set up and the program running on the first computer is synchronized with the program running on the server on the basis of the stored state and the logged state changes.

An In another embodiment of the invention, there is an arrangement for synchronizing a program running on a first computer with a program running on a server has a first computer and a server, with the first computer and the server being connected to one another via a connection. The program running on the server continues to run even when the server is not connected to the first computer, and the server produces state changes in the running program. The server is set up such that the following steps can be performed:

as soon as when an existing connection between the first computer and the server has been interrupted, the server stores the state of the first computer within the program running on the server;

the program running on the server is continued after the connection to the first computer has been interrupted, with state changes in the program running on the server being logged, at least some of which state changes are caused by the server; and

the first computer is reconnected to the server, and the stored state and the logged state changes are taken as a basis for synchronizing the program running on the first computer with the program running on the server.

A In still another embodiment of the invention, there is a computer-readable storage medium stores a computer program for synchronizing a program running on a first computer with a program running on a server, where the program running on the server continues to run and makes state changes even when the server is not connected to the first computer. The computer program for synchronization has the following method steps when it is executed by a processor:

as soon as when an existing connection between the first computer and the server has been interrupted, the server stores the state of the first computer within the program running on the server;

the program running on the server is continued after the connection to the first computer has been interrupted, with state changes in the program running on the server being logged, at least some of which state changes are caused by the server; and

the first computer is reconnected to the server, and the stored state and the logged state change are taken as a basis for synchronizing the program running on the first computer with the program running on the server.

A In yet another embodiment of invention, there is a computer program element is used for synchronizing a program running on a first computer with a program running on a server, where the program running on the server continues to run and makes state changes even when the server is not connected to the first computer. When the computer program element is executed by a processor, the following method steps arc is performed:

as soon as when an existing connection between the first computer and the server has been interrupted, the server stores the state of the first computer within the program running on the server;

the program running on the server is continued after the connection to the first computer has been interrupted, with state changes in the program running on the server being logged, at least some of which state changes are caused by the server; and

the first computer is reconnected to the server, and the stored state and the logged state change are taken as a basis for synchronizing the program running on the first computer with the program running on the server.

The invention provides, for the first time, a simple way of synchronizing distributed programs, that is to say a distributed application, in which the server causes state changes even though a connection to one or more mobile computers has been interrupted, when a connection to the respective computer has been set up again.

This means that Hence, even in the case of such a distributed application, computer users are able, for the first time, to reenter the distributed application when the connection to the server has been interrupted.

This is particularly advantageous for applications in which the connection is unstable, that is to say particularly in the case of applications via a channel which is subject to a high level of interference, for example a connection via a radio interface, particularly based on GSM, DECT or UMTS.

The invention can be implemented both using software, that is to say using a computer program, and using an electronic special circuit, that is to say using hardware.

Preferred developments of the invention can be found in the dependent claims.

The refinements The embodiments described below relate to the method, to the arrangement, to the computer-readable storage medium and to the computer program element.

In one refinement aspect of the invention, the logged state changes as a series of commands for running through all the states since interruption of the connection and/or the respective new states, that is to say, in other words, the results of the state changes, are concurrently logged.

This refinement aspect permits simple reproducibility of the state changes, which ensures fast, efficient and computation-time saving synchronization of the programs.

In another refinement aspect of the invention, synchronization involves deciding whether the commands for running through all the states up to a current state or the result of the state change are/is transmitted to the first computer, depending on what is more economical with regard to a required bandwidth for transmission and/or with regard to a required computation capacity for synchronizing the first computer.

This refinement aspect achieves further optimization of the bandwidth requirement or of the computation-time requirement for synchronization.

In addition, the program running from the server can be accessed using a program running on a second [lacuna] computer. In principle, the program running from the server can be accessed by any number of other computers using programs running on these respective computers to the program running on the server.

In addition, one development has provision for the first computer and/or the further computers to be mobile computers.

A mobile computer is to be understood, by way of example, to mean a Notebook, a Personal Digital Assistant (PDA) or else a mobile phone with an integrated computer, each of which are connected to the server using an Internet protocol, for example (in the case of mobile phones, using the WAP, for example).

The first computer and/or the further computers can be connected to the server via a radio interface, particularly via a radio interface based on GSM, DECT or UMTS.

The invention is particularly suitable for such a radio link because this radio link is subject to a high level of interference, and such a connection is frequently interrupted.

The state changes in the program running on the server can be logged for a predetermined period of time.

This refinement aspect ensures that only a volume of data whose size can be processed is actually logged, so that synchronization between the programs on the computer and on the server is possible with a feasible level of complexity, that is to say with an acceptable bandwidth requirement and/or computation time requirement.

If the predetermined period of time has been exceeded, or if a particular number of state changes has been exceeded, then a further refinement aspect of the invention involves the server no longer permitting any further connection setup for the respective computer.

The invention is particularly suitable for use in one of the following applications:

multi-user engineering through access to a shared server application,

administration of distributed applications,

multi-player games, or

multi-player games in which the players use mobile computers to access the game provided by the server via a radio interface.

Synchronization can be performed transparently for the program running on the server within middleware on the server, which achieves considerable speeding-up of the synchronization, since said synchronization is performed using special hardware in the middleware on the server.

### BRIEF DESCRIPTION OF THE DRAWINGS

Exemplary embodiments of the invention are shown in the figures and are explained in more detail below. in the figure,

FIG. 1 FIG. 1 shows an arrangement with a server and a plurality of mobile computers which are connected to one another via a communications network;.

FIG. 2 FIG. 2 shows a sketch showing the execution over time of an interactive program based on an exemplary embodiment of the invention;.

FIG. 3 FIG. 3 shows a flowchart showing an individual method steps of an exemplary embodiment of the invention.

### DETAILED DESCRIPTION OF THE PREFERRED EMBODIMENTS

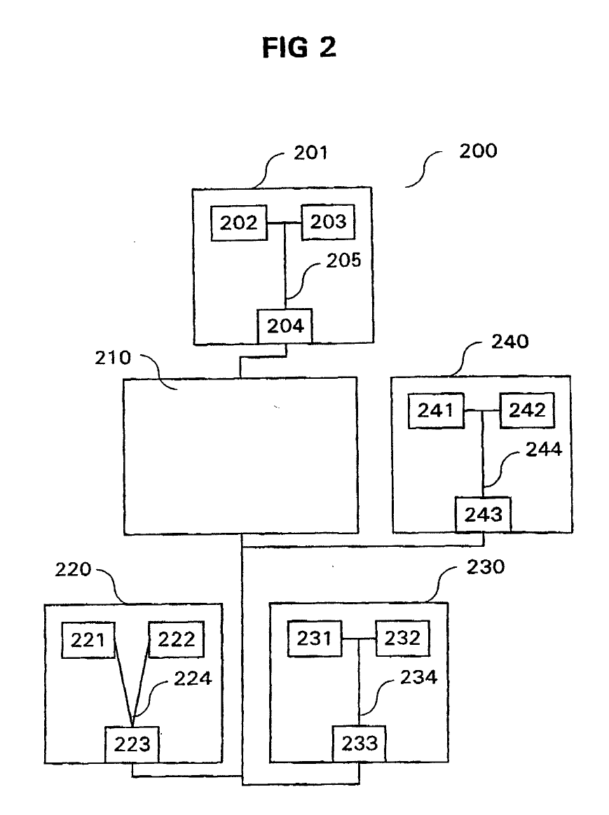

FIG. 2 shows a communications arrangement 200 with a server 201, a first mobile computer 220, a second mobile computer 230 and an nth mobile computer 240 (n=1, . . . , m, where m denotes the number of mobile computers in the communications arrangement 200).

The mobile computers 220, 230, 240 are connected to the server 201 via a communications network 210.

The server 201 and the mobile computers 220, 230, 240 each have:

a processor 202, 221, 231, 241,

a memory 203, 222, 232, 242,

an input/output interface 204, 223, 233, 243, which are respectively connected to one another via a computer bus 205, 224, 234, 244.

The communications network 210 provides radio links based on the UMTS standard.

The individual mobile computers 220, 230, 240 and the server 201 communicate with one another using the WAP.

The server 201 provides an interactive application in the form of a program for use by the mobile computers 220, 230, 240.

The program is used, that is to say states of the program are changed in the server, via the communications link respectively set up to the server 201 by a mobile computer 220, 230, 240.

The mobile computers 220, 230, 240 each store a copy of the interactive program in their memory 222, 232, 242.

The interactive program is respectively executed by the processors 221, 231, 241. The interactive program is controlled by the processor 202 in the server 201.

In accordance with the exemplary embodiment, the interactive program is a computer program for a real-time strategy game, for example the game Command&Conquer™, which can be played by the users of the mobile computers 220, 230, 240 in a joint communications session managed by the server 201.

Within the context of managing the respective game session in accordance with the exemplary embodiment, the server 201 manages the following attributes:

the type of game,

the minimum number of players in the game within a communications session,

the maximum number of players in the game within a communications session,

an indication of whether the respective player has reentered the game when a connection has been interrupted,

an identifier for the respective game, which the server 201 uses for uniquely associating every message from a mobile computer 220, 230, 240 with a respective communications session and game,

synchronization objects which are used to synchronize the states of the program as described below,

a time statement indicating for how long a connection can be interrupted, so that a player can still reenter the game when a connection has been set up again.

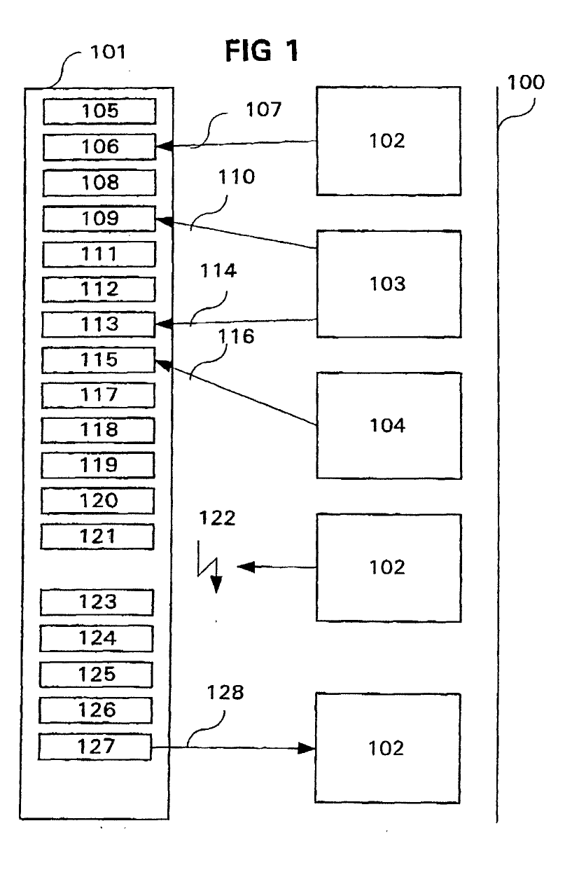

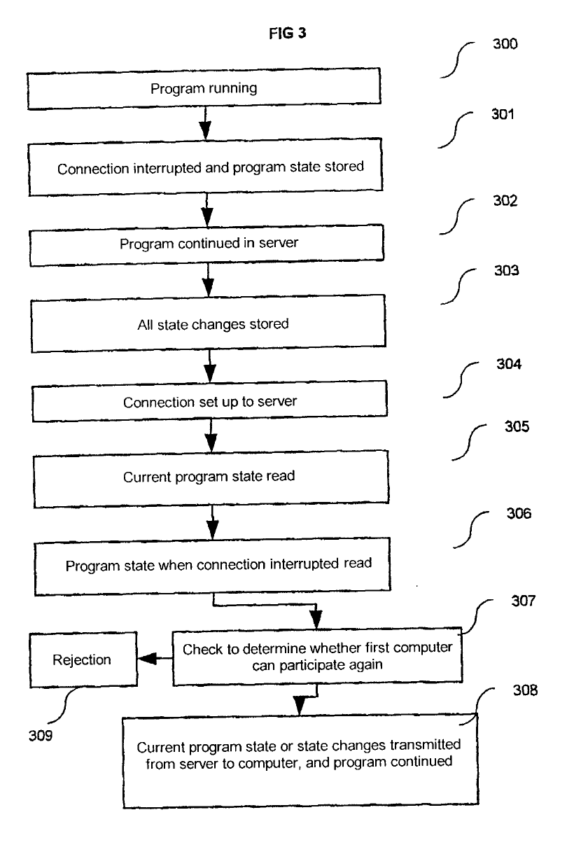

The exemplary embodiment of the invention is explained in more detail below with reference to FIG. 1 and FIG. 3.

FIG. 1 shows a time profile 100 for the various states in the interactive program 101.

It is assumed below that n players are participating in the game, and the corresponding n mobile computers 220, 230, 240 have already set up a communications link to the server 201.

This situation is symbolized by a program 102 on the first mobile computer 220, a program 103 on the second mobile computer 230 and a program 104 on the nth computer 240.

When a user of a mobile computer 220, 230, 240 performs an action within the game, for example, when an object is selected by pressing a key or clicking a mouse, the corresponding selected information is communicated to the server 201 when a connection exists, and the state of the interactive program changes from an initial state before processing of the selected information to a final state when the selected information has been processed by the server 201.

FIG. 1 shows, symbolically, a first state 105 which changes to a second state 106 as a result of internal control by the server 101.

When a state change request 107 has been received from the first computer, symbolized by an arrow, a state change to a third state 108 is made.

Following a change to a fourth state 109, where the state change has been produced by the server 101 itself, FIG. 1 uses an arrow to symbolize a further state change request 110, this time by the program on the second mobile computer 103, in the form of an external state change request 110. On the basis of the external state change request 110, the interactive program 101 in the server 201 changes to a fifth state 111.

Following a change to a sixth state 112 and to a seventh state 113, which state changes have been generated by the server 201 itself, the interactive program 101 changes to an eighth state 115 on the basis of a further external state change request 114 sent by the program 103 on the second mobile computer 230.

On the basis of a further external state change request 116, this time sent by the program 104 on the nth computer 240, the interactive program 101 changes to a ninth state 117.

Further state changes to further states 118, 119, 120 and 121 are generated by the server 101.

It is now assumed, to simplify illustration, that the connection between the first computer 220 and the server 201 is interrupted, which is symbolized by an interruption arrow 122 in FIG. 1.

The connection to the first computer 220 can be interrupted as a result of an interruption in the physical connection itself, which is detected by the server 201. The interruption in the connection can also be detected from signaling which has not occurred, that is to say from a message which has not been received and is fundamentally required on the basis of prescribed game rules.

Although the connection to one of the participating mobile computers has now been interrupted, the server 201 makes further state changes which result in further states 123, 124, 125, 126 of the interactive program 101.

Clearly, the The server 201 can take the interrupted connection to the first computer 220 as a basis for implementing at least one of the following measures for ensuring that the program 101 continues for the further computers 230, 240 in particular:

the interactive program can immediately be continued with the further participants, that is to say with the further computers,

the interactive program 101 can immediately be terminated,

the participant whose connection has been interrupted can be replaced by a further participant, with the option of the exiting participant's game state within the program 101 being transferred,

the mobile computer whose connection has been interrupted can be simulated by the interactive program 101 itself if the program continues,

measures can be implemented in order [lacuna] for reentry of the participant who has exited from the real-time strategy game as a result of an interruption in the connection, [lacuna] wishes to reenter the game; an example of such preparation for reentry is the starting of a timer which indicates for how long it is actually still possible for the exiting participant to reenter the real-time strategy game.

From the time at which the connection is interrupted, the server 201 logs all state changes in the interactive program 101 and stores them in a log file.

If the first computer 220 now wishes to reenter the game, that is to say the interactive program 101, when a connection has been set up again, the server 201 transmits the state changes made since the connection was terminated, or the overall state in which the interactive program 101 finds itself when there is a request for the first computer 220 to reenter, to the first computer 220 in the form of a state update message 128 (symbolized by reference numerals 127 and 128 in FIG. 1).

The procedure is clearly shown again in FIG. 3 in the form of a flowchart.

During a first phase (block 300), the interactive program 101 is running.

In a further step, the The connection to a participant is interrupted and the current program state at the time of the connection being interrupted is stored (step 301)(301).

The program is continued in further steps in the server taking into account state change messages from the further mobile computers 230, 240, which are still connected to the server 201, and as a result of state changes which are produced by the server 201 itself (block 302).

While the interactive program 101 continues, all the state changes and/or all the final states which have been caused by a state change are stored in the server's memory 203 in a log file (step 303)(303).

When the first computer 220 has set up a connection to the server 201, and following the requested reentry of the first mobile computer 220 into the interactive program 101 (block 304), the server 201 reads the current program state (step 305)(305) and the program state when the connection to the first mobile computer 220 was interrupted from the memory 203 of the server 201 (step 306)(306).

In addition, a check is carried out to determine whether the first computer 220 can be involved in the interactive program 101 again (step 307)(307).

If this is the case, then the current program state or the state changes made is/are transmitted to the first mobile computer 220 by the server 201, the first mobile computer 220 is involved in the interactive program 101 again, and the interactive program 101 is continued, this time with the first mobile computer 220 as a participant again (step 308)(308).

If the first computer 220 can no longer be involved in the interactive program 101, then the requested accession to the interactive program is rejected (step 309(309) and the program 101 is continued without the first computer 220 as a participant.

In step 308 308, the data requiring a smaller amount of bandwidth for data transmission are transmitted. In other words, this means that the overall current program state is transmitted to the first mobile computer 220 if the data volume to be transmitted is smaller for the current overall program state than for transmitting the state changes made since the connection was interrupted, and vice versa.

An example of elements which are transmitted for the current program state is, by way of example, the structure of the game card for a mission in the computer game “Command&Conquer™”, the structure of the overall model of the mission, the structure of the individual objects within the game card and various general parameters describing, by way of example, the level of difficulty or other elements in the game.

Using the logged state changes in the log file, the program running on the first computer 220 is synchronized with the interactive program 101 running on the server 201.

When synchronization has been performed, the first computer 220 is fully involved in the game again, that is to say in the interactive program 101, and the interactive program 101 continues to run normally again.

The text below explains a few alternatives to the exemplary embodiment illustrated above.

In one alternative embodiment, following termination of the connection, the program, that is to say the real-time strategy game, is autonomously executed further in the first mobile computer 220 The result of this is that the first mobile computer 220 produces state changes other than those in the interactive program 101 on the server 201, which continues to run in the server 201 despite the connection having been interrupted.

If an attempt is now made, following fresh connection setup, to involve the first mobile computer 220 in the game again as a participant, then consistency problems arise between the individual states in the interactive program 101 on the server and the program 102 on the first mobile computer 220.

These consistency problems can be eliminated in a variety of known ways for resolving data inconsistencies in distributed databases.

In line with the alternative exemplary embodiment, the program state in the first mobile computer 220 is overwritten by the program state in the server 201.

It should be pointed out that the invention is not limited to a real-time strategy game or to a computer game at all. The mechanism can be applied to any form of interactive program which continues to run when a connection to a participant has been interrupted and which involves state changes being made by the server.

The invention is also not limited to a specific radio link, that is to say to a communications network based on a mobile radio standard, such as GSM or UMTS. Any type of communications link can be used within the scope of the invention, for example a normal landline network link.

In this context, it will be noted that the type and duration of connection termination can be based on a suitable measure on the server. It is thus possible, by way of example, in the event of a prescribed period of time following termination of the connection between the server and the first (mobile) computer being exceeded, to permit further re-entry of the first computer into the program running on the server only if the sum of the changes is loaded onto the first computer (client) by the server instead of the individual change steps. This has the advantage that the server logs the individual state changes since the connection to the first computer was terminated only for a certain period of time, and hence the list containing including commands remains transparent, i.e. implementable, in particular.

The server can also autonomously decide that the connection has been terminated when a particular period of time has been exceeded in which it has not been possible to interchange any data between the server and the client. In this case, the server introduces suitable measures to perpetuate the state of the client for reentry.

In this context, it is possible for the state changes taking place as the program progresses to be noted (logged) for the client, or else for an action on the client itself to be simulated and logged—for the time of the terminated connection. If the client reports back following the time for which the connection is terminated, then it is notified of the changes in the state machine for the overall distributed program, whether in the form of the individual state transitions or else as the result of the state transitions.

This document cites the following publication:

[1] EP 0 862 123

1. A method for synchronizing a program running on a first computer with a program running on a server, where the program running on the server continues to run and makes state changes even when the server is not connected to the first computer,
a) in which, as soon as an existing connection between the first computer and the server has been interrupted, the server stores the state of the first computer within the program running on the server;
b) in which the program running on the server is continued after the connection to the first computer has been interrupted, with state changes in the program running on the server being logged, at least some of which state changes are caused by the server; and
c) in which the first computer is reconnected to the server, and the stored state and the logged state changes are taken as a basis for synchronizing the program running on the first computer with the program running on the server.

2. The method as claimed in claim 1,
in which the logged state changes as a series of commands for running through all the states since interruption of the connection and/or the respective new states are concurrently logged.

3. The method as claimed in claim 1 or 2,
in which synchronization involves deciding whether the commands for running through all the states up to a current state or the result of the state change are/is transmitted to the first computer, depending on what is more economical with regard to a required bandwidth for transmission and/or with regard to a required computation capacity for synchronizing the first computer.

4. The method as claimed in one of claims 1 to 3, in which a program running on a second computer is used to access the program running on the server.

5. The method as claimed in one of claims 1 to 4, in which the first computer and/or the second computer used are mobile computers.

6. The method as claimed in one of claims 1 to 5, in which the first computer is connected to the server via a radio interface, particularly [lacuna] GSM, DECT or UMTS.

7. The method as claimed in one of claims 1 to 6, in which the state changes in the program running on the server are logged for a predetermined period of time.

8. The method as claimed in one of claims 1 to 7, used in one of the following applications: multi-user engineering through access to a shared server application, administration of distributed applications, multi-player games, or multi-player games in which the players use mobile computers to access the game provided by the server via a radio interface.

9. The method as claimed in one of claims 1 to 8, in which synchronization is performed transparently for the program running on the server within middleware on the server.

10. An arrangement synchronizing a program running on a first computer with a program running on a server, where the program running on the server continues to run and makes state changes even when the server is not connected to the first computer, having
a) the first computer,
b) the server, with the first computer and the server being connected to one another via a connection,
c) where the server is set up such that the following steps can be performed:
(1) as soon as an existing connection between the first computer and the server has been interrupted, the server stores the state of the first computer within the program running on the server;
(2) the program running on the server is continued after the connection to the first computer has been interrupted, with state changes in the program running on the server being logged, at least some of which state changes are caused by the server; and
(3) the first computer is reconnected to the server, and the stored state and the logged state changes are taken as a basis for synchronizing the program running on the first computer with the program running on the server.

11. The arrangement as claimed in claim 10,
having at least one further second computer, which is connected to the server via a connection.

12. The arrangement as claimed in claim 10 or 11,
in which the first computer and/or at least one second computer, which is connected to the server via a connection, is/are mobile computers.

13. The arrangement as claimed in one of claims 10 to 13,
in which the connection from the first computer and/or from at least one second computer to the server is a radio connection, particularly based on GSM, DECT or UMTS.

14. The arrangement as claimed in one of claims 10 to 13,
in which the server has middleware within which the synchronization can be carried out transparently for the program running on the server.

15. The arrangement as claimed in one of claims 10 to 14,
used in one of the following applications:
multi-user engineering through access to a shared server application,
administration of distributed applications,
multi-player games, or
multi-player games in which the players use mobile computers to access the game provided by the server via a radio interface.

16. A computer-readable storage medium storing a computer program for synchronizing a program running on a first computer with a program running on a server, where the program running on the server continues to run and makes state changes even when the server is not connected to the first computer, said computer program, when executed by a processor, having the following method steps:
as soon as an existing connection between the first computer and the server has been interrupted, the server stores the state of the first computer within the program running on the server;
the program running on the server is continued after the connection to the first computer has been interrupted, with state changes in the program running on the server being logged, at least some of which state changes are caused by the server; and
the first computer is reconnected to the server, and the stored state and the logged state changes are taken as a basis for synchronizing the program running on the first computer with the program running on the server.

17. A computer program element for synchronizing a program running on the first computer with a program running on a server, where the program running on the server continues to run and makes state changes even when the server is not connected to the first computer, said computer program element, when executed by a processor, having the following method steps:
as soon as an existing connection between the first computer and the server has been interrupted, the server stores the state of the first computer within the program running on the server;
the program running on the server is continued after the connection to the first computer has been interrupted, with state changes in the program running on the server being logged, at least some of which state changes are caused by the server; and
the first computer is reconnected to the server, and the stored state and the logged state changes are taken as a basis for synchronizing the program running on the first computer with the program running on the server.
